(19) United States
(12) Patent Application Publication
(10) Pub. No.: US 2011/0117408 A1
(43) Pub. Date: May 19, 2011

(54) Battery Assembly

(76) Inventor: Stuart B. Lennox, Los Angeles, CA (US)

(21) Appl. No.: 12/618,532

(22) Filed: Nov. 13, 2009

(51) Int. Cl. H01M 2/10

(52) U.S. Cl. 429/99; 29/623.1

(57) ABSTRACT

A battery may include a plurality of cells, each cell having an elongate insulating case with a first end face including a positive terminal and a second end face including a negative terminal. a plurality of cells, each cell having an elongate insulating case with a first end face including a positive terminal and a second end face including a negative terminal. Positive and negative bus bars may be connected to the corresponding terminals of all of the plurality of cells. Each of the positive bus bar and the negative bus bar may have an L-shaped cross section including a first planar conductor joined at an angle of approximately 90 degrees to a second planar conductor. Each first planar conductor may be spot welded to the respective terminals of the plurality of cells and each second planar conductor may be disposed alongside the insulating cases of the plurality of cells.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to rechargeable batteries for electronic equipment.

2. Description of the Related Art

Rechargeable batteries are nearly ubiquitous in modern life. Rechargeable batteries enable portable electrical and electronic equipment including communications devices, personal entertainment devices, medical equipment, power tools, and hybrid and electric vehicles. Rechargeable batteries may be contained within portable equipment, or may be contained within a battery pack external to the equipment being powered.

In this patent, the term “cell” means a component that produces electrical energy by means of an electrochemical reaction. The electrochemical reaction may occur within an electrochemical system including an anode material and a cathode material separated by an electrolyte. A cell may have a positive terminal and a negative terminal. The cell may generate a voltage between the positive terminal and the negative terminal due to the electrochemical reaction within the cell. The voltage generated by a cell is typically determined by the electrochemical system within the cell. Known electrochemical systems for rechargeable cells include, for example, lead acid, nickel cadmium, nickel metal hydride, nickel iron, nickel zinc, lithium ion, lithium cobalt oxide, lithium iron phosphate, and other electrochemical systems. The current capacity and energy capacity of a cell are typically determined by the physical size and specific construction of the cell.

In this patent, the term “battery” means an assembly of two or more cells. The cells within a battery may be electrically connected in series, in parallel, or in a combination of series and parallel. Typically, the cells within a battery use the same electrochemical system and have the same voltage and the same energy capacity. The cells within a battery may be permanently assembled such that the battery may be considered as an integrated non-repairable component.

In this patent, the term “battery pack” means an assembly of two or more batteries. The batteries within a battery pack may be electrically connected in series to produce a multiple of the voltage of a single battery. The batteries within a battery pack may be electrically connected in parallel to produce higher current than a single battery. The batteries within a battery pack may be electrically connected in a series-parallel combination to produce both higher voltage and higher current than a single battery. A battery pack may be configured to allow individual batteries to be removed and replaced.

### DESCRIPTION OF THE DRAWINGS

FIG. 1 is a front perspective view of a battery.

FIG. 2 is a back perspective view of the battery.

FIG. 3 is an end view of the battery.

FIG. 4 is a top view of the battery.

FIG. 5 is a front view of the battery.

FIG. 6 is a block diagram of a battery pack.

FIG. 7 is a flow chart of a process for assembling a battery.

Throughout this description, elements appearing in figures are assigned three-digit reference designators, where the most significant digit is the figure number where the element was first described. An element that is not described in conjunction with a figure may be presumed to have the same characteristics and function as a previously-described element having the same reference designator.

### DETAILED DESCRIPTION

### Description of Apparatus

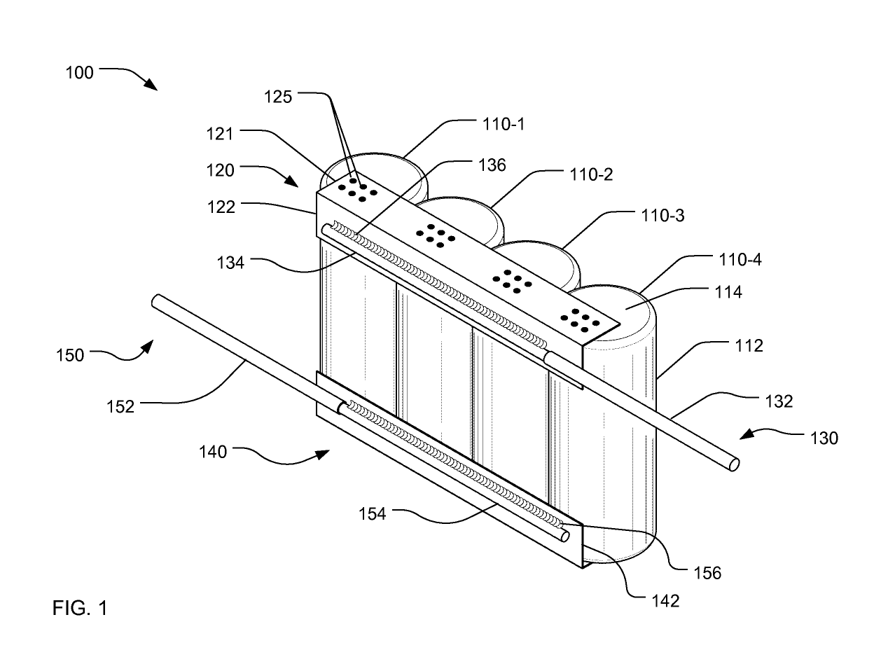

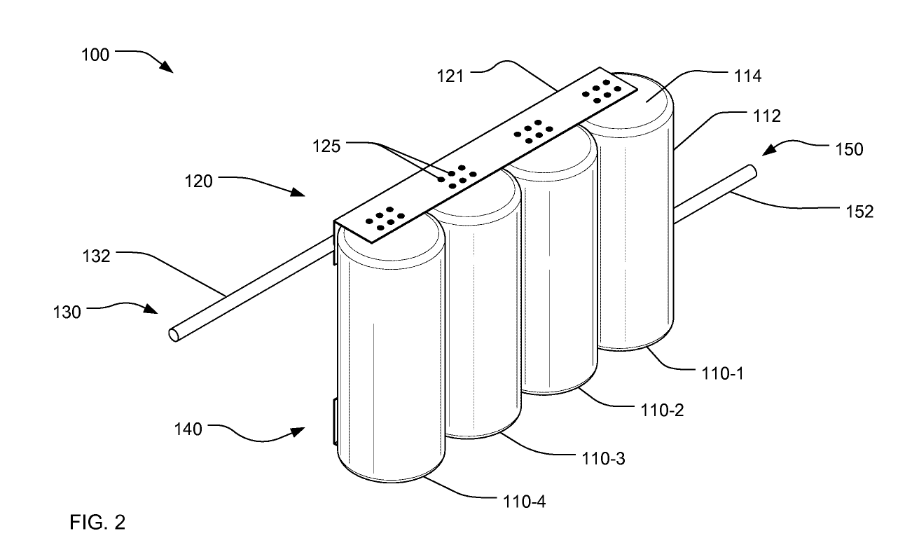

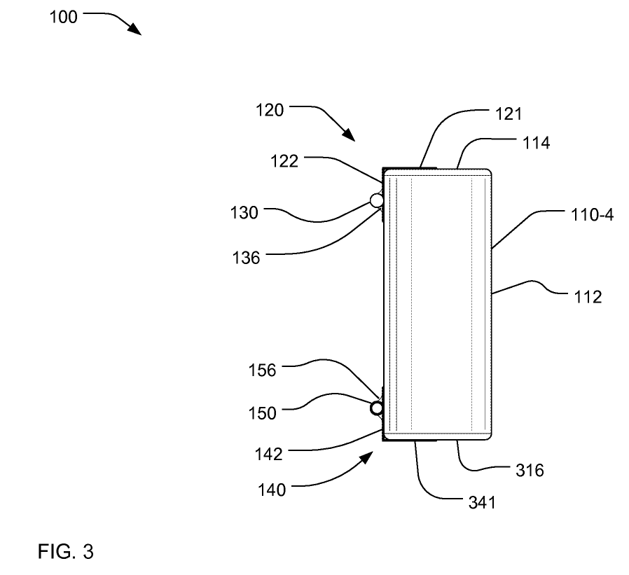

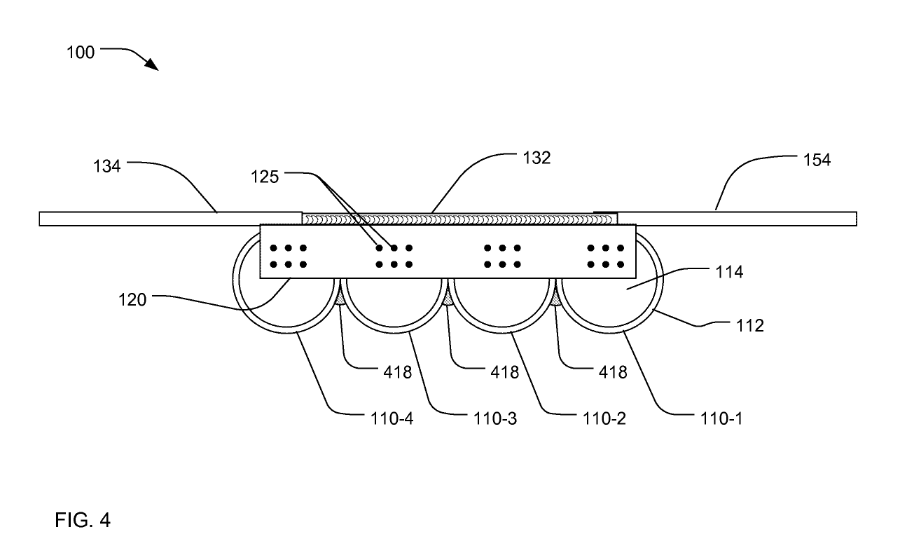

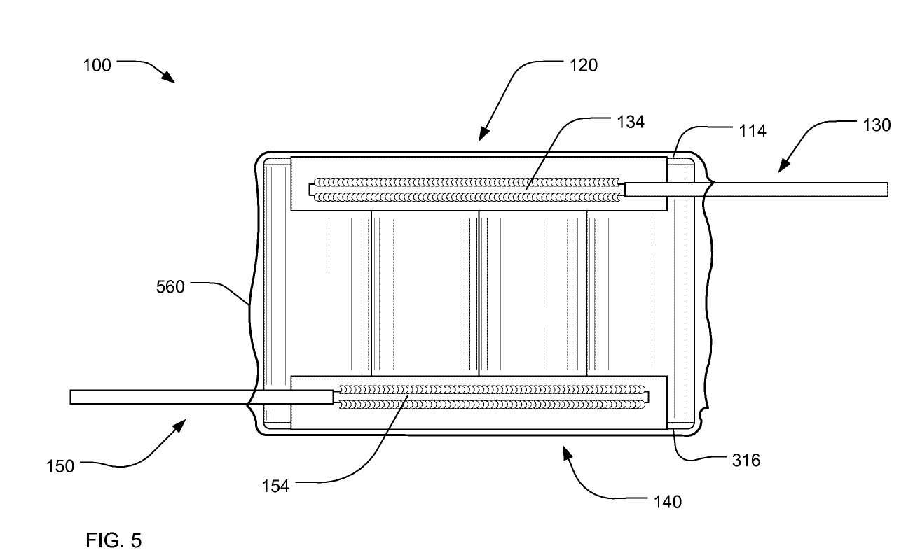

FIG. 1 and FIG. 2 are front and back perspective views, respectively, of an exemplary battery 100. FIG. 3, FIG. 4, and FIG. 5 are top, side, and front views, respectively, of the battery 100. Geometrically descriptive terms such as top, bottom, side, front, horizontal, and vertical refer to the battery as shown in the drawings, but do not imply an absolute orientation of the battery. The battery 100 may be used in various positions such as upside down.

Referring now to FIG. 1, FIG. 2, and FIG. 3, the exemplary battery 100 may include four cells 110-1, 110-2, 110-3, 110-4. A battery may include two cells, three cells, eight cells, or some other number of cells. The number of cells may be more or fewer than the four cells shown in the exemplary battery 100. The voltage of the battery 100 may be the same as the voltage of the individual cells. The current and energy capacity of the battery 100 may be roughly proportional to the number of cells in the battery.

Each of the cells may include an elongate insulating case 112 having a first end face 114 and a second end face 316 (FIG. 3). The elongate insulating case 112 may be in the shape of a right circular cylinder such that the first and second end faces are circular. Cells may have other shapes, such as rectangular. All or a portion of the first end face 114 may be either a positive or negative electrical terminal of the cell 110. All of a portion of the second end face 316 may be the other electrical terminal of the cell.

The four cells 110-1, 110-2, 110-3, 110-4 may be disposed in a linear array with either the positive terminal of each cell or the negative terminal of each cell facing up. In the following description, it is assumed that the cells 110-1, 110-2, 110-3, 110-4 are disposed with their respective positive terminals facing up.

A positive bus bar 120 may be electrically connected to the positive terminals of each of the four cells 110-1, 110-2, 110-3, 110-4. The positive bus bar 120 may be an elongate conductor with an L-shaped cross section. The positive bus bar 120 may include a horizontal (as shown in FIGS. 1-3) planar conductor 121 joined to a vertical planar conductor 122 at an angle of approximately 90 degrees. The positive bus bar 120 may be formed, for example, by folding a length of conductive sheet metal parallel to its long axis.

The horizontal planar conductor 121 may be electrically connected to the positive electrode of each of the cells 110-1, 110-2, 110-3, 110-4 by welding. In the exemplary battery 100, the horizontal planar conductor 121 is connected to each cell 110-1, 110-2, 110-3, 110-4 by six spot welds 125. The number of spots welds 125 at each cell may be selected to achieve a desired electrical resistance value. More or fewer than six spot welds may be used at each cell. The horizontal planar conductor may be electrically connected to the positive electrode of each of the cells 110-1, 110-2, 110-3, 110-4 by laser welding.

The vertical planar conductor 122 may extend alongside the insulating cases 112 of the cells 110-1, 110-2, 110-3, 110-4. Disposing the vertical planar conductor alongside the cases of the cells may allow the positive bus bar 120 to have a large cross-sectional area without substantially increasing the volume or outline dimensions of the battery 100. Having a large cross-sectional area may reduce the electrical resistance of the positive bus bar 120.

A negative bus bar 140 may be similar in construction to the positive bus bar 120. The negative bus bar may be electrically connected to the negative terminals of each of the four cells 110-1, 110-2, 110-3, 110-4. The negative bus bar 140 may include a horizontal planar conductor 341 (FIG. 3) joined to a vertical planar conductor 142 at an angle of approximately 90 degrees to form an elongate conductor with an L-shaped cross section. The horizontal planar conductor 341 may be electrically and mechanically connected to the negative terminal 316 (FIG. 3) of each of the cells 110-1, 110-2, 110-3, 110-4 by means of spot welds (not visible). The vertical planar conductor 142 may extend alongside the insulating cases 112 of the cells 110-1, 110-2, 110-3, 110-4.

The vertical planar conductors 122, 142 of the positive and negative bus bars 120, 140, respectively, may extend along the same side of the cells 110-1, 110-2, 110-3, 110-4, as shown in FIGS. 1-3. Alternatively, the vertical planar conductors 122, 142 of the positive and negative bus bars 120, 140, respectively, may extend along opposite sides of the cells 110-1, 110-2, 110-3, 110-4.

A positive lead wire 130 and a negative lead wire 150 may be connected respectively to the positive horizontal planar conductor 122 and the negative horizontal planar conductor 142. The positive and negative lead wires 130, 150 may include respective insulated portions 132, 152 and respective uninsulated portions 134, 154. The insulated portions 132, 152 may extend to a length required to connect the battery 100 to other batteries or load devices (not shown). The insulated portions 132, 152 may extend from opposing ends of the battery 100 (as shown in FIGS. 1, 2, 4, 5) or from the same end of the battery 100 (not shown). The uninsulated portions 134, 154 of the lead wires may be electrically connected to the respective horizontal planar conductors 122, 142 by soldering, brazing, welding, or other connection technique.

When cells, such as the cells 110-1, 110-2, 110-3, 110-4, are connected in parallel within a battery such as the battery 100, battery capacity and reliability may be enhanced if the parallel-connected cells contribute about equally to the current provided to a load, and share about equally in the current provided by a charger. Providing relatively uniform series resistances from the lead wires to each of the cells 110-1, 110-2, 110-3, and 110-4 may encourage uniform distribution of charging and discharging current between the cells.

To provide relatively uniform series resistance from the lead wires to each of the four cells 110-1, 110-2, 110-3, 110-4, the uninsulated portions 134, 154 of the lead wires may be in electrical contact with the respective horizontal planar conductors 122, 142 across at least half of the width of the horizontal planar conductors 122, 142. For batteries having more than four cells, the lead wires may be connected such that the electrical contact between the lead wires and the bus bars extends over a distance of at least (N−2)D, where N is the number of cells in the battery and D is a diameter of each cell.

As shown in FIG. 1, the uninsulated portions 134, 154 of the lead wires may be connected with the respective horizontal planar conductors 122, 142 by respective continuous solder fillets 136, 156. The uninsulated portions 134, 154 of the lead wires may be connected with the respective horizontal planar conductors 122, 142 by plural discontinuous soldered or welded connections across the prescribed width.

The positive bus bar 120 and the negative bus bar 140 may be formed from a metal material that is electrically conductive and weldable to the terminals of the cells 110-1, 110-2, 110-3, 110-4. When the lead wires 120, 140 are connected to the bus bars by soldering, the bus bar material may also be solderable. For example, the bus bars may be formed from nickel or nickel alloy sheet metal. Thicker sheet metal may provide lower electrical resistance. Thinner sheet metal may be easier to form, weld, and/or solder. The thickness may be selected as a compromise between electrical resistance and manufacturability. The thickness of the sheet metal may be between 0.005 inch and 0.025 inch. The thickness of the sheet metal may be, for example, about 0.012 inch.

Referring now to FIG. 4, adjacent pairs of the cells 110-1, 110-2, 110-3, 110-4 may be bonded together by fillets 418 of an adhesive such as an epoxy, silicone, or polyurethane adhesive material. Bonding the adjacent cells together may increase the mechanical durability of the battery 100 and may facilitate handling the cells during fabrication of the battery 100.

Referring now to FIG. 5, an insulating jacket 560 may cover and protect the positive and negative terminals 114, 316 of the cells, the positive and negative bus bars 120, 140, and the uninsulated portions 134, 154 of the lead wires 130, 150. The insulating jacket 560 may be, for example, a heat-shrinkable plastic tube that is disposed over the battery 100 and shrunk to conform to the shape of the battery 100. The insulating jacket 560 may be applied by another method such as conformal coating. The insulating jacket 560 may be transparent, as shown in FIG. 5, or may be wholly or partially opaque.

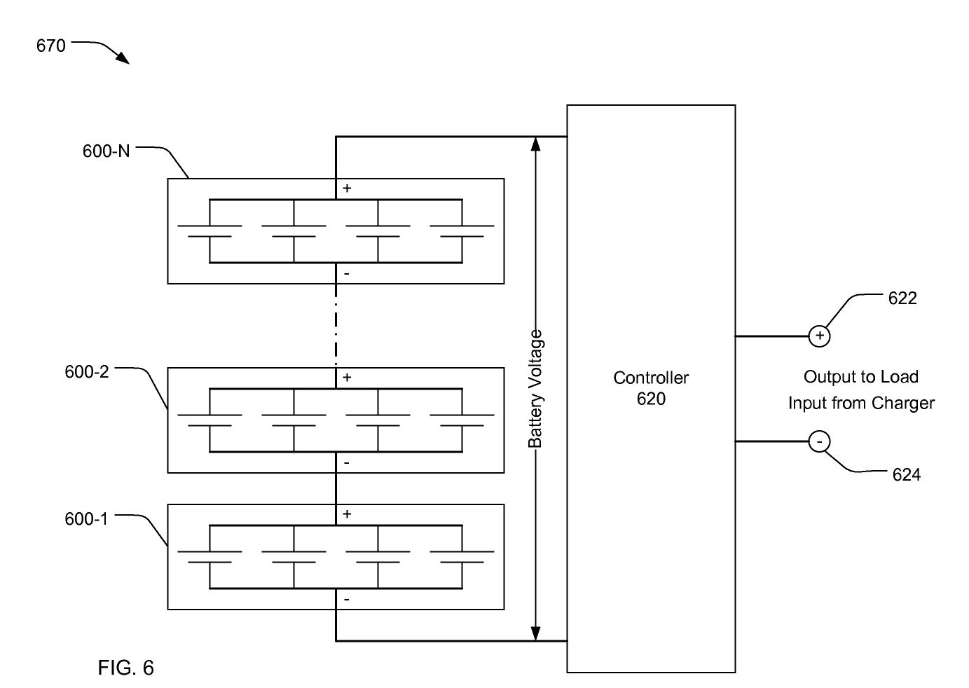

Referring now to FIG. 6, an exemplary battery pack 670 may include a plurality of N batteries, (600-1, 600-2 . . . 600-N), a controller 620, and input/output terminals 622, 624. Each of the N batteries may be the battery 100 of FIGS. 1-5. In the exemplary battery pack 670, the N batteries are connected electrically in series. The series-connected batteries (600-1, 600-2 . . . 600-N) may produce a battery voltage approximately N times the output voltage of a single battery 100.

The input/output terminals 622, 624 may be used both to provide current to a load device (not shown) and to receive current from a charger (not shown). The charger may be a conventional line powered battery charger, a generator, a solar panel, or some other source of charging current. The controller 620 may be adapted to interrupt current flow between the batteries (600-1, 600-2 . . . 600-N) and the output terminals 622, 624 if the battery voltage is below a first predetermined voltage and if the battery voltage is above a second predetermined voltage. Interrupting current flow from the batteries when the battery voltage falls below the first predetermined voltage may protect the batteries from damage due to over discharging. Interrupting current flow to the batteries when the battery voltage rises above the second predetermined voltage may protect the batteries from damage due to over charging. The controller may also interrupt current flow between the batteries (600-1, 600-2 . . . 600-N) and the output terminals 622, 624 if the temperature of the batteries and/or the controller 620 exceeds a respective predetermined maximum temperature. The first predetermined voltage and the second predetermined voltage may depend on the battery type and construction. The first predetermined voltage and the second predetermined voltage may be set in accordance with battery manufacturer's recommendations.

### DESCRIPTION OF PROCESSES

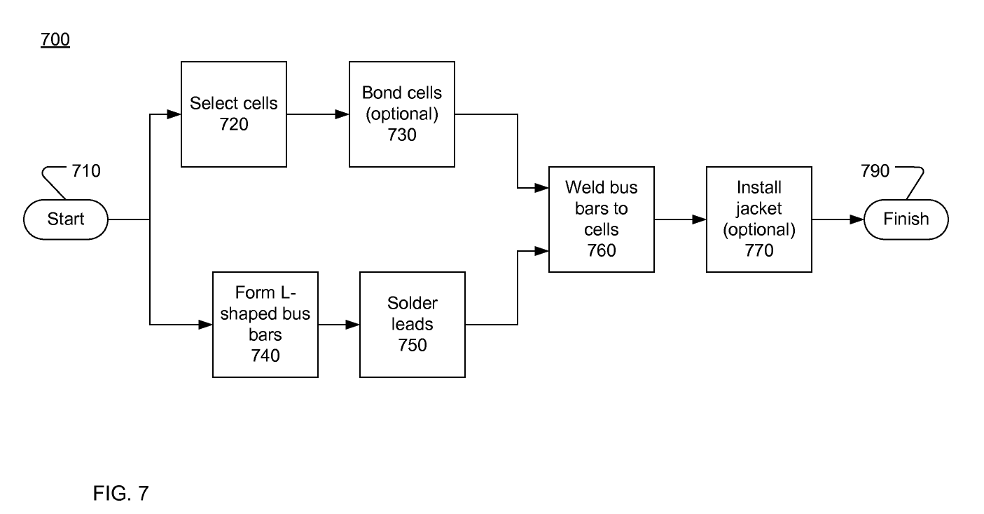

Referring now to FIG. 7, a process 700 for assembling a battery, such as the battery 100, may start at 710 and finish at 790. For ease of explanation, the following description assumes that only a single battery is assembled during each repetition of the process 700. However, the process 700 is adaptable to batch manufacturing, and a large number of batteries may be assembled concurrently.

At 720, a plurality of cells may be selected for incorporation into the battery being assembled. Since the cells will be electrically connected in parallel within the completed battery, at 720 cells may be selected that are suitable for parallel connection. As an example of a cell selection technique, a plurality of cells may each be charged to a uniform nominal charge level. The nominal charge level may be, for example, 50% of a full charge. The voltage of each cell may then be measured, and cells having nearly the same voltage may be selected as suitable for parallel connection. Cells suitable for parallel connection may have voltages that match within a small fraction of a volt, for example within 0.01 volt, when charged to the nominal charge level. The criteria for selecting suitable cells may be different for different cells types and different cell manufacturers. The criteria or guidelines for selecting cells suitable for parallel connection may typically be provided by the cell manufacturer. The selection of cells at 720 may be performed by the cell manufacturer, the battery assembler, or some other entity.

At 730, the cells selected at 720 may optionally be bonded into a linear array. Bonding the cells may improve the durability of the completed battery and may facilitate handling the cells during subsequent actions in the process 700. For example, the cells selected at 730 may be disposed in a fixture that holds the cells in alignment. A bead or fillet of adhesive, such as the adhesive 418 shown in FIG. 4, may then be applied between adjacent cells and cured to bond the adjacent cells.

At 740, two bus bars having an L-shaped cross-section may be formed. For example, a suitable shape may be cut from sheet metal and folded to form an elongate L-shaped conductor.

At 750, respective lead wires may be connected to the bus bars by soldering or other connection technique. The lead wires may be connected such that the electrical contact between the lead wires and the bus bars extends over at least half of the length of the bus bars. For batteries including more than four cells, the lead wires may be connected such that the electrical contact between the lead wires and the bus bars extends over a distance of at least (N−2)D, where N is the number of cells in the battery being assembled and D is a diameter of each cell.

At 760, the bus bars may be welded to the contacts of the cells such that a positive bus bar connects the positive contact of each cell and a negative bus bar connects the negative contact of each cell. The bus bars may be welded to the contacts after the lead wires are soldered to the bus bars to avoid exposing the cells to the high temperatures required to make soldered connections.

At 770, an insulating jacket may optionally be installed. For example, a heat-shrinkable plastic tube may be threaded over the cells and bus bars with the lead wires extending from one or both open ends of the tube. The tube may then be shrunk to conform to the shape of the battery. The insulating jacket may cover the cell contacts, the bus bars, and uninsulated portions of the leads wires. An insulating jacket may be applied by another process such as conformal coating.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting” of and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A battery, comprising:
a plurality of cells, each cell having an elongate insulating case with a first end face including a positive terminal and a second end face including a negative terminal
a positive bus bar connected to the positive terminals of all of the plurality of cells
a negative bus bar connected to the negative terminals of all of the plurality of cells
wherein the positive bus bar and the negative bus bar each have an L-shaped cross section including a first planar conductor joined at an angle of approximately 90 degrees to a second planar conductor, the first planar conductor spot welded to the respective terminals of the plurality of cells and the second planar conductor disposed alongside the insulating cases of the plurality of cells.

2. The battery of claim 1, further comprising:
positive and negative lead wires electrically connected to the second planar conductors of the positive and negative bus bars, respectively.
wherein each of the positive and negative lead wires is electrically connected with the respective second planar conductor along at least half of a length of the second planar conductor.

3. The battery of claim 2, wherein each of the positive negative lead wires is soldered to the respective second planar conductor.

4. The battery of claim 2, wherein
the number of cells is N, where N is an integer greater than or equal to four
each of the positive and negative lead wires is electrically connected to the respective second planar conductors along a length greater than (N−2)D, where D is a diameter of each cell.

5. The battery of claim 1, wherein each of the plurality of cells is generally a right circular cylinder having a cylindrical insulating case and opposed circular first and second end faces.

6. The battery of claim 1, wherein the bus bars comprise a material that is electrically conductive, solderable, and weldable.

7. The battery of claim 6, wherein the material is selected from nickel and nickel alloys.

8. The battery of claim 1, wherein the plurality of cells comprises from two to eight cells.

9. The battery of claim 1, wherein the plurality of cells consists of four cells.

10. The battery of claim 1, wherein the plurality of cells are all of a same type.

11. The battery of claim 11, wherein the type of the plurality of cells is selected from nickel cadmium, nickel metal hydride, nickel iron, nickel zinc, lithium ion, lithium cobalt oxide, and lithium iron phosphate.

12. The battery of claim 1, further comprising:
an insulating jacket that substantially covers the positive bus bar, the negative bus bar, and the positive terminals and negative terminals of the plurality of batteries.

13. A battery pack, comprising:
a plurality of batteries electrically connected in series, wherein each of the plurality of batteries comprises:
a plurality of cells, each cell having an elongate insulating case with a first end face including a positive terminal and a second end face including a negative terminal
a positive bus bar connected to the positive terminals of all of the plurality of cells
a negative bus bar connected to the negative terminals of all of the plurality of cells
wherein the positive bus bar and the negative bus each have an L-shaped cross section including a first planar conductor joined at an angle of approximately 90 degrees to a second planar conductor, the first planar conductor spot welded to the respective terminals of the plurality of cells and the second planar conductor disposed alongside the cases of the plurality of cells.

14. A method of assembling a battery, comprising:
selecting a plurality of cells suitable for connection in parallel
fabricating a positive bus bar and a negative bus bar, wherein the positive bus bar and the negative bus bar each have an L-shaped cross section including a first planar conductor joined at an angle of approximately 90 degrees to a second planar conductor
electrically connecting respective lead wires to the second planar conductors of the positive bus bar and the negative bus bar
after electrically connecting respective lead wires, welding the first planar conductor of the positive bus bar to the positive terminals of all of the plurality of cells and welding the first planar conductor of the negative bus bar to the negative terminals of all of the plurality of cells.

15. The method of 14, further comprising:
installing a jacket over at least a portion of the battery after welding the positive bus bar and the negative bus bar.

16. The method of claim 15, wherein the jacket substantially covers the positive bus bar, the negative bus bar, and the positive terminals and negative terminals of the plurality of batteries.

17. The method of claim 14, further comprising:
bonding adjacent batteries of the plurality of batteries.

18. The method of claim 14, wherein electrically connecting respective lead wires further comprises:
connecting each lead wire to the respective second planar conductor over a distance greater than half of a length of the second planar conductor.

19. The method of claim 18, wherein
the battery being assembled includes N cells, where N is an integer greater than or equal to four,
electrically connecting respective lead wires includes connecting each lead wire to the respective second planar conductor over a distance greater than (N−2)D, where D is a diameter of each cell.
